(19) United States
(12) Patent Application Publication
(10) Pub. No.: US 2006/0045308 A1
(43) Pub. Date: Mar. 2, 2006

(54) Camera and method for watermarking film content

(75) Inventors: Thomas A. Abrams, Snohomish, WA (US); Theodore C. Tanner JR., Hollywood, WA (US)

Correspondence Address: BINGHAM MCCUTCHEN LLP, THREE EMBARCADERO CENTER, SAN FRANCISCO, CA, 94111-4067, US

(73) Assignee: Microsoft Corporation, Redmond, WA (US)

(21) Appl. No.: 10/934,256

(22) Filed: Sep. 2, 2004

(51) Int. Cl. G06K 9/00

(52) U.S. Cl. 382/100

(57) ABSTRACT

Camera and methods are provided for watermarking film content. A watermark, which can have information, such as a tracking message, is generated. The watermark preferably can be represented as correlated noise that cannot be visually noticed by a casual observer of the film content, but can later be extracted from the film content to obtain the embedded information, e.g., during a forensics study in a piracy investigation, to provide end-to-end asset tracking and management, or to prevent viewing of the film content. The watermark is optically applied to the optical image to generate a watermarked optical image, e.g., by absorbing light from selected regions within the optical image. The optical image may optionally be analyzed, in which case, the watermark can be applied to the optical image based on the analysis. Lastly, the photographic film is exposed to the watermarked optical image, thereby capturing the optical image and watermark on film. Camera and methods are provided for modifying film content. An optical image is temporally dividing into first and second optical image segments. The first optical image segment is analyzed, and the second optical image segment is modulated based on the analysis, e.g., by absorbing light from selected regions within the second optical image segment. A reflective MEMS array can be used to advantageously provide high resolution modulation of the second optical image segment. Photographic film is then exposed to the modulated optical image segment. As a practical example, an optical image can be watermarked, or an optical image can be corrected prior to exposure of the film using this technique.

### FIELD OF THE INVENTION

The present inventions generally relate to systems and methods for discouraging piracy and tracking of movie content, and in particular, for watermarking or otherwise manipulating movie film.

### BACKGROUND OF THE INVENTION

Currently, there are various digital watermarking techniques used to protect film content from piracy. In these digital watermarking techniques, a hidden message is embedded in a digitized version of the image or image sequence for the purpose of establishing ownership, tracking the origin of the images, preventing unauthorized copying, or conveying additional information relating to the film content. To be useful, the digital watermark must not be noticeable to a casual observer when viewing the film content, but at the same time, be robust enough so that it can be extracted from digital copies, as well as optical copies (e.g., copies of cinema movies made by a camcorder), of the film content, through an automated process. Once detected, the watermark can be read to provide information on the film content. For example, in the context of preventing piracy, the source of the piracy or distribution channel can be determined.

Digital watermarking can be applied from the time at which the film is transformed into digital video data to the time that the film content is displayed to the viewing public in cinemas. Thus, it can be said that movie studios and those entities that have a legitimate commercial stake in the film content have been successful to some extent in preventing piracy once the film has been transformed into digital video data. Yet, the biggest threat comes from studio insiders who have access to raw film footage, which has commercial value by itself, before it has been digitized, or otherwise watermarked.

There thus remains a need to protect or otherwise embed information into a movie film before transforming it into a digital format.

### SUMMARY OF THE INVENTION

In accordance with a first aspect of the present inventions, a method of watermarking film content is provided. The method comprises receiving an optical image. In one method, the optical image is in the visible light spectrum, but can also be in other spectra, such as the infrared or ultraviolet spectra. The method further comprises generating a watermark, which can be accomplished in any suitable manner. For example, the watermark can comprise a watermark pattern, and can have information, such as a tracking message incorporated therein. The watermark can also be represented as correlated noise that cannot be visually noticed by a casual observer of the film content, but can later be extracted from the film content to obtain the embedded information, e.g., during a forensics study in a piracy investigation, to provide end-to-end asset tracking and management, or to prevent viewing of the film content.

The method further comprises optically applying the watermark to the optical image to generate a watermarked optical image, e.g., by absorbing light from selected regions within the optical image. The optical image may optionally be analyzed, in which case, the watermark can be applied to the optical image based on the analysis. For example, the analysis can comprise determining one or more spatial regions in the optical image, e.g., those spatial regions that have a specific grey-scale value or fall within a specific grey-scale range, and selecting one or more of these regions to which the watermark will be applied. In this manner, the watermark can be applied to selected regions of the optical image that would be less noticeable to the casual observer. To provide for a more efficient analysis, the optical image can be transformed to digital video data, so that it can be digitally processed.

Lastly, the method comprises exposing photographic film to the watermarked optical image, thereby capturing the optical image and watermark on film. A movie can be created by repeatedly performing the watermark generation, watermark application, and exposure steps over a series of film frames. In some methods, the film is exposed to the optical image in real-time.

If the optical image is analyzed, real-time exposure of the film can be accomplished because a frame of film need only be exposed to the optical image during a certain period of time, thereby allowing the remaining time to be used for processing the optical image. For example, once the optical image is received it can be temporally divided into first and second optical image segments, so that the first optical image segment can first be analyzed, and then the watermark can be applied to the second optical image segment based on this analysis. Notably, because the received optical image will typically be continuously changing due to movement of the source of the optical image, the first and second optical image segments will typically not be identical. However, because, the processing time takes only a few milliseconds, there is still a high degree of correlation between the first and second optical image segments, and therefore, analysis of the first optical image segment can be accurately used to apply the watermark to the second optical image segment.

In accordance with a second aspect of the present inventions, the previously described methods can be incorporated into a camera. In this case, a lens is used to receive the optical image, a watermarking device is used to generate watermark control signals and optionally analyze the optical image, an optical modulator, such as a reflective Micro Electrical-Mechanical System (MEMS) array, is configured for modulating the optical image in response to the watermark control signals, and a film advancer is used to expose the photographic film to the modulated optical image. An optical transducer, such as one or more Charge Coupled Device (CCD) imagers, can be used to transform the optical image into digital video data for analysis by the watermarking device. If the optical image is to be temporally divided, an optical switch, such as a rotating shutter, can be configured to be placed in a first state that transmits a first time segment of the optical image to the watermarking device (or intervening optical transducer), and a second state that transmits a second time segment of the optical image to the optical modulator. The camera may have a housing that conveniently contains the lens, watermarking device, optical modulator, and film advancer.

In accordance with a third aspect of the present inventions, a method of incorporating tracking information into film content is provided. The method comprises receiving an optical image, and generating tracking information, such as the date of original film exposure, take number, director of photography, camera exposure levels, interim print identification, distribution information, etc. The method further comprises modulating the optical image with the tracking information, e.g., by absorbing light from selected regions within the optical image. The tracking information can be applied to the optical image as correlated noise, so that it is not visible to a casual observer of the film content, or can be applied, so that it can be seen by a casual observer of the film content. Lastly, the method comprises exposing photographic film to the modulated optical image, thereby capturing the optical image and tracking information on film. A movie can be created by repeatedly performing the tracking information generation, optical image modulation, and exposure steps over a series of film frames, which can be accomplished in real-time.

In accordance with a fourth aspect of the present invention, the previously described methods can be incorporated into a camera. In this case, a lens is used to receive the optical image, a message generator is used to generate the tracking information, an optical modulator, such as a reflective MEMS array, is configured for modulating the optical image with the tracking information, and a film advancer is used to expose the photographic film to the modulated optical image. The camera may have a housing that conveniently contains the lens, message generator, optical modulator, and film advancer.

In accordance with a fifth aspect of the present inventions, a method of modifying film content is provided. The method comprises receiving an optical image. In one method, the optical image is in the visible light spectrum, but can also be in other spectra, such as the infrared or ultraviolet spectra. The method further comprises temporally dividing the optical image into first and second optical image segments, analyzing the first optical image segment, modulating the second optical image segment based on the analysis, e.g., by absorbing light from selected regions within the second optical image segment, and exposing photographic film to the modulated optical image segment. Temporally dividing the optical image into segments allows the film content to be modified at the moment of its creation. A movie can be created by repeatedly performing the division, analysis, modulation, and exposure steps over a series of film frames.

Notably, because the received optical image will typically be continuously changing due to movement of the source of the optical image, the first and second optical image segments will typically not be identical. However, because, the processing time takes only a few milliseconds, there is still a high degree of correlation between the first and second optical image segments, and therefore, analysis of the first optical image segment can be accurately used to apply the watermark to the second optical image segment. To provide for a more efficient analysis, the first optical image segment can be transformed to digital video data, so that it can be digitally processed.

The analysis of the first optical image segment can comprise indirectly determining one or more spatial regions in the second optical image segment to be modulated. For example, some methods may comprise determining spatial regions in the first optical image segment that have a specific grey-scale value, fall within a specific grey-scale range, or have a specific grey-scale contrast, and selecting one or more of the spatial regions of the first optical image segment. One or more spatial regions of the second optical image segment corresponding with the selected spatial region(s) of the first optical image segment can then be modulated. As a practical example, an optical image can be watermarked, or an optical image can be corrected prior to exposure of the film using this method.

In accordance with a sixth aspect of the present inventions, the previously described methods can be incorporated into a camera. In this case, a lens is used to receive the optical image, an optical switch can be used to divide the optical image into first and second optical image segments, a controller can be used to analyze the first optical image segment and generate control signals, an optical modulator, such as a reflective Micro Electrical-Mechanical System (MEMS) array, can be configured for modulating the optical image in response to the control signals, and a film advancer can be used to expose the photographic film to the modulated optical image segment. An optical transducer, such as one or more Charge Coupled Device (CCD) imagers, can be used to transform the optical image into digital video data for analysis by the controller. The camera may have a housing that conveniently contains the lens, optical switch, controller, optical modulator, and film advancer.

In accordance with a seventh aspect of the present inventions, a camera for modifying film content is provided. The camera comprises a lens for receiving an optical image, a controller configured for generating control signals, a reflective MEMS array configured for modulating the optical image in response to the control signals (e.g., for applying a watermark and/or tracking information and/or image correction, etc.), and a film advancer configured for exposing photographic film to the modulated optical image. The controller may optionally be configured for analyzing the optical image and generating the control signals based on the analysis. For example, the controller may select one or more spatial regions in the optical image to be modulated by the reflective MEMS array. The camera may optionally comprise an optical transducer for transforming the optical image into digital video data and/or an optical switch configured for temporally dividing the optical image into optical image segments, as previously described above. The camera may have a housing that conveniently contains the lens, controller, MEMS array, and film advancer.

Other features of the present invention will become apparent from consideration of the following description taken in conjunction with the accompanying drawings.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is a block diagram of a camera constructed in accordance with a preferred embodiment of the present invention;

FIG. 2 is a plan view of a mask used by the camera of FIG. 1 to filter a watermark;

FIG. 3 is a plan view of a watermark pattern filtered through the mask of FIG. 2;

FIG. 4 is a cross-sectional view of a reflective Micro Electrical-Mechanical System (MEMS) element used in the camera of FIG. 1, wherein the MEMS element is shown in a relaxed state;

FIG. 5 is a cross-sectional view of a reflective Micro Electrical-Mechanical System (MEMS) element used in the camera of FIG. 1, wherein the MEMS element is shown in a deflected state;

FIG. 6 is a partially cutaway plan view of a reflective MEMS array used in the camera of FIG. 1;

FIG. 7 is a timing diagram illustrating optical image processing and exposure sequences;

FIG. 8 is a flow diagram illustrating the operation of the camera of FIG. 1 in watermarking film content;

FIG. 9 is a block diagram of camera constructed in accordance with another preferred embodiment of the present invention; and

FIG. 10 is a block diagram of a camera constructed in accordance with still another preferred embodiment of the present invention.

### DETAILED DESCRIPTION OF THE PREFERRED EMBODIMENTS

Referring to FIG. 1, an exemplary camera 100 constructed in accordance with the present invention is functionally shown. The camera 100 is configured for simultaneously capturing and watermarking an optical image 200 of a subject 202 on photographic film. In this manner, the film is watermarked at the moment of exposure, thereby closing any security gap that previously existed between the time that the film was exposed to the time that the film content was transferred to digital video data. The optical image of any subject can be captured, but for illustrative purposes, an optical image of a lighted candle is simplistically shown as being captured by the camera 100. Although the optical image is typically captured in the visible light spectrum, the optical image may also be captured in other light spectrums, e.g., the infrared or ultraviolet spectrum. The camera 100 can be designed to take still photographs of the subject 202, but in the illustrated embodiment, the camera 100 is described as taking a series of photographs of the subject 202 to create a moving picture, i.e., a movie of the subject 202.

In performing these functions, the camera 100 generally comprises a lens 102 for receiving the optical image 200, an optical transducer 104 for transforming the optical image 200 into digital video data, an optical modulator 106 for optically modulating the optical image 200, a watermarking device 108 for generating and applying a watermark to the optical image 200 via the optical modulator 106, a film advancer 110 for holding and advancing photographic film 204 in a manner that exposes the film 204 to the modulated optical image, and an optical switch 212 that selectively transmits the optical image 200 to the optical transducer 104 and optical modulator 106.

The lens 102 can take the form of any standard lens or lens assembly used on prior art cameras, and operates to focus the optical image 200 into an optical image beam that is transmitted along a common optical path 206 to the optical switch 212. The optical switch 212 operates to enable the camera 100 to process and watermark the optical image in real-time, meaning that the photographic film 204 is exposed to light entering the camera 100 within a few milliseconds. In performing this function, the optical switch 212 operates, so that the continuously received optical image 200 is captured on discrete frames of the film 204 to create a movie of the subject 202, and for each frame, the optical image can be processed and subsequently watermarked before exposing the film to the optical image.

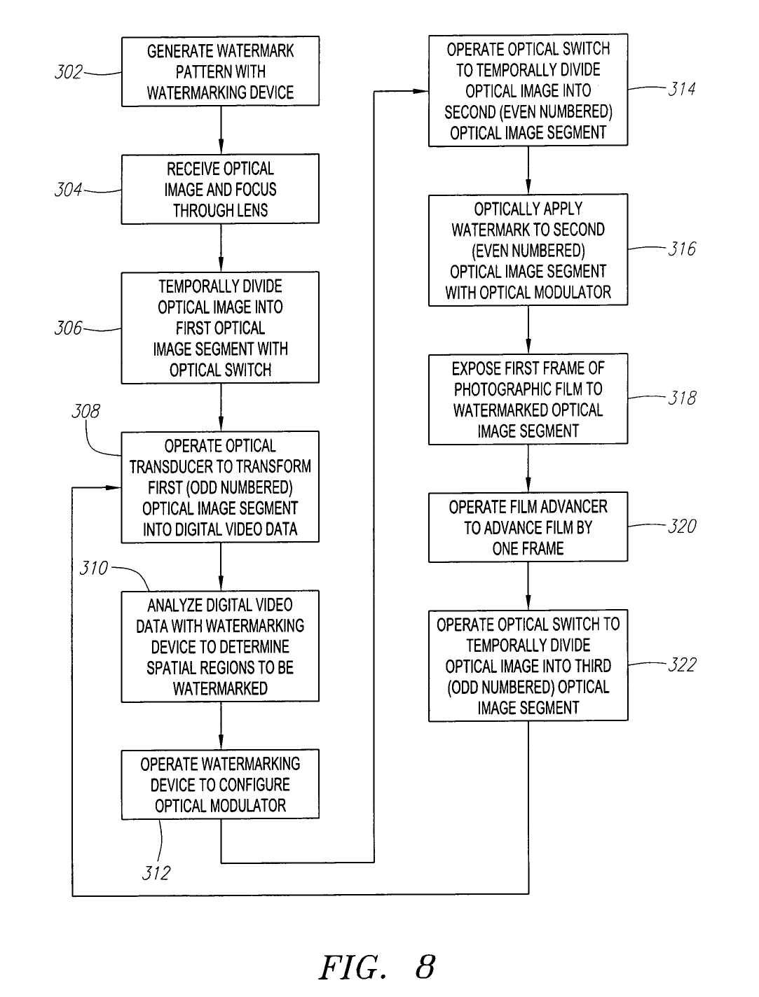

For example, FIG. 7 illustrates a standard 42 millisecond time frame (at 24 frames per second) during which certain operations are performed to create one movie frame. Notably, during the initial 26 milliseconds of the time frame, the currently advanced film frame is not exposed to an optical image, which allows a predefined period of time to process and watermark the optical image. During the last 16 milliseconds of the time frame, the currently advanced film frame is exposed to the watermarked optical image.

To this end, the optical switch 112 may take the form of any suitable device, such as a rotating shutter, which is commonly used in movie cameras today for the purpose of simultaneously viewing the optical image that will be used to exposed the film. The optical switch 112 operates in two states: a processing state, wherein the optical image travels along an optical processing path 208 and eventually processed; and an exposure state, wherein the optical image 204 travels along an optical exposure path 210 and eventually modulated and used to expose the film 204. In the illustrated embodiment, the optical processing path 208 is an a collinear relationship with the common optical path 206, and the optical exposure path 210 is in a perpendicular relationship with the common optical path 206. It should be noted, however, that the common optical path 206 and optical processing and exposure paths 208, 210 can be in any relationship that allows the optical image to travel from the common optical path 206 along either of the optical processing and exposure paths 208, 210 without mechanical or optical interference from the other.

Thus, it can be appreciated that over a series of film frames, the optical switch 212 operates to temporally divide the optical image into optical image segments that are alternately transmitted along the optical processing and exposure paths 208, 210, so that pairs of optical image segments, each pair having an optical image segment that will be processed and an optical image segment that will be modulated, will respectively fall within a series of film frames. Notably, an optical image segment that is processed will not be identical to an optical image segment that is subsequently modulated. Because the film frames are shot at a relatively high rate, however, the respective processed and modulated optical image segments will virtually be identical. Thus, the optical image segments that will ultimately expose the film frames will be accurately modulated even though the corresponding processed optical image segments are somewhat removed from each other in time (about 26 milliseconds).

The optical transducer 104 is placed within optical processing path 208, so that it receives the optical image when the optical switch 212 is in the processing state. In the illustrated embodiment, the optical transducer 104 takes the form of a high resolution video Charge Coupled Device (CCD) imager that transforms the optical image into high resolution video data, e.g., video data having 800×600, 1024×768, 1280×1024, 1600×1200, 1280×720, or even higher pixel resolution. Whichever resolution value is selected, the aspect ratio of the CCD imager resolution preferably matches the aspect ratio of the film frames, so that there is a high degree of spatial correlation between the optical image that is processed and the optical image that will be used to expose the film. It should be noted that if the camera 100 is used to create a black-and-white movie, a single CCD image will be used for the optical transducer. In this case, the optical transducer 104 will output a single grey-scale value for each pixel. If the camera 100 is used to create a color movie, three CCD imagers to respectively capture blue, red, and yellow colors will be used. In this case, the blue CCD imager will output a grey-scale value representing the saturation of blue in each pixel, the red CCD imager will output a grey-scale value representing the saturation of red in each pixel, and the yellow CCD imager will output a grey-scale value representing the saturation of yellow in each pixel. Thus, the optical transducer 104 will output three grey-scale values (blue, red, yellow) for each pixel.

The watermarking device 108 is configured for analyzing the digital video data (i.e., the grey-scale values) received from the optical transducer 104, and for generating and applying a watermark to the optical image transmitted along the optical exposure path 210. In the illustrated embodiment, the watermark is applied to the optical image in the spatial domain as correlated noise. Any standard watermarking algorithm can be used to generate the watermark that will be applied to the optical image. The watermarking device 108 also incorporates tracking information or indicia, such as date of original film exposure, take number, director of photography, camera exposure levels, interim print identification, distribution information, etc., which provides end-to-end asset tracking and management, as well as forensic information in video piracy investigations

In the illustrated embodiment, the watermark is dynamically applied to different spatial regions of the optical image over a series of film frames, so that the watermark will not be as noticeable to a casual observer. As will become apparent from the detailed discussion below, this dynamic spatial application of the watermark also provides more varied watermarking information from which the tracking information can be detected. In effect, the watermark, which takes the form of correlated noise, is spread out over the time domain.

To this end, the watermarking device 108 comprises a set of encryption keys 114, a message generator 116, a watermark pattern generator 118, and a watermark controller 120. It should be noted that these components are functional in nature, and are not meant to limit the structure that performs these functions in any manner. For example, several of the functional blocks can be embodied in a single device, or one of the functional blocks can be embodied in multiple devices. Also, the functions can be performed in hardware, software, or firmware.

The watermark pattern generator 118 receives information from the message generator 116 and generates a specific watermark using one of the keys 114. Preferably, the watermark pattern generator 118 changes the keys as necessary. For example, the watermark pattern generator 118 may use a new key 114 after a specific number of movie frames or may randomly or pseudo-randomly select the keys 114. By changing the watermark key, additional security is provided to the watermarking process, since knowledge of the key used for one movie frame does not provide knowledge of a different key for another frame. As such, different watermark patterns will be generated. This prevents an unauthorized person from determining the watermark pattern by averaging multiple frames to cancel the dynamic image content, thereby reinforcing the static watermark pattern. Also, a watermark pattern that dynamically changes over time may be less detectable by a casual viewer of the film content. Preferably, if multiple keys are used, the number is relatively small, so that it is easier to electronically ascertain or extract the watermark during the detection process.

The message generator 116 generates the tracking information that will be encoded into the watermark by the watermark pattern generator 118. In doing this, the message generator 116 may receive an input from the user, in which case, the camera will have a standard user interface (not shown) that allows entry of current information, such as the take number, director of photography, interim print information, distribution information, etc. The message generator 116 may also receive internal input from, e.g., a current date or time from an internal clock, or camera exposure levels from the lens 102.

In the illustrated embodiment, the watermark controller 120 takes the form of a digital signal processor (DSP) that analyzes the video data received from the optical transducer 104 and determines the spatial regions in the optical image to which the watermark pattern should be applied. In the illustrated embodiment, the watermark controller 120 selects the spatial regions where watermarks are less likely to be visually noticeable by a casual observer. The watermark controller 120 accomplishes this by selecting pixels that have a particular grey-scale value, e.g., 128, or that fall within a particular grey-scale value, e.g., between 126-130. In the case of color, the watermark controller 120 may select pixels having a particular combination of grey-scale values (e.g., 10 (blue), 80 (red), and 45 (yellow)) or a particular combination of grey-scale ranges (e.g., 8-12 (blue), 78-82 (red) and 43-47 (yellow)).

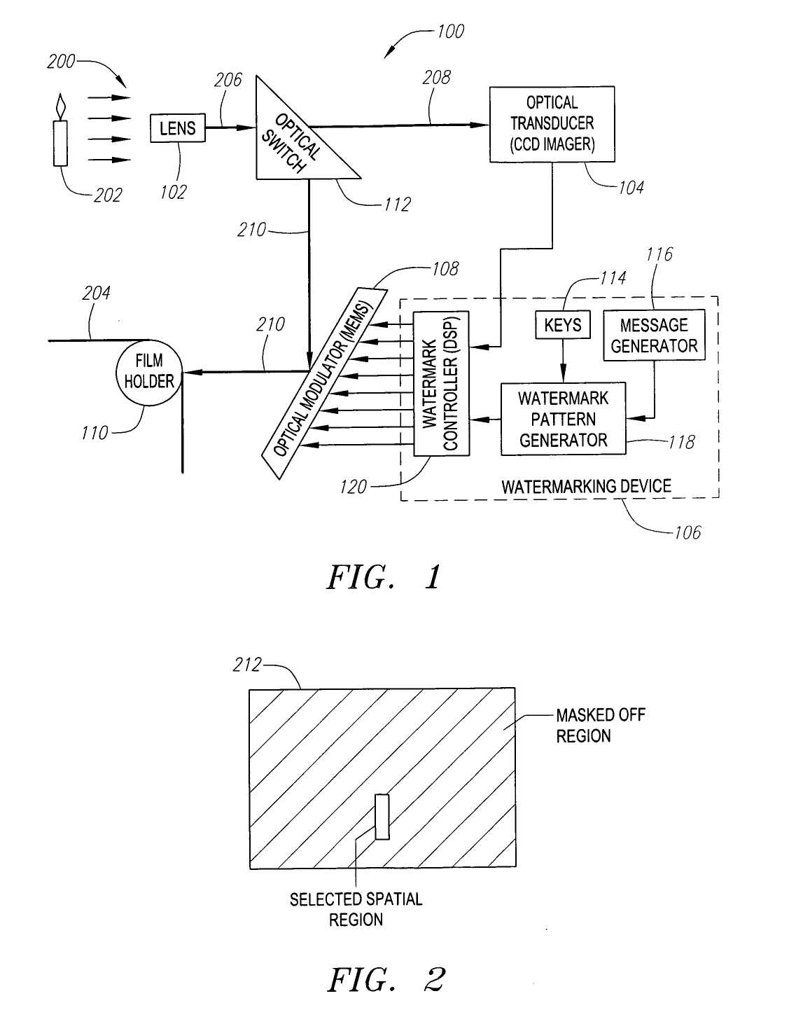

As illustrated in FIG. 2, once these spatial region(s) are located, the watermark controller 120 generates a mask 212 through which the watermark pattern will be spatially filtered. That is, the mask 212 will be used by the watermark controller 120 to suppress modulation of the entire optical image with the exception of the selected spatial regions to which the watermark will be applied. To this end, the mask 212 can be mathematically represented as a digital matrix of 1's and 0's having a resolution equal to that of the analyzed video image data, with the 1's located in the selected regions, and the 0's located in the masked off regions. Thus, when the watermark pattern is combined with the mask 212, pixel-sized regions of the watermark pattern spatially corresponding to the 0's will be suppressed, whereas pixel-sized regions of the watermark pattern corresponding to the 1's will be expressed.

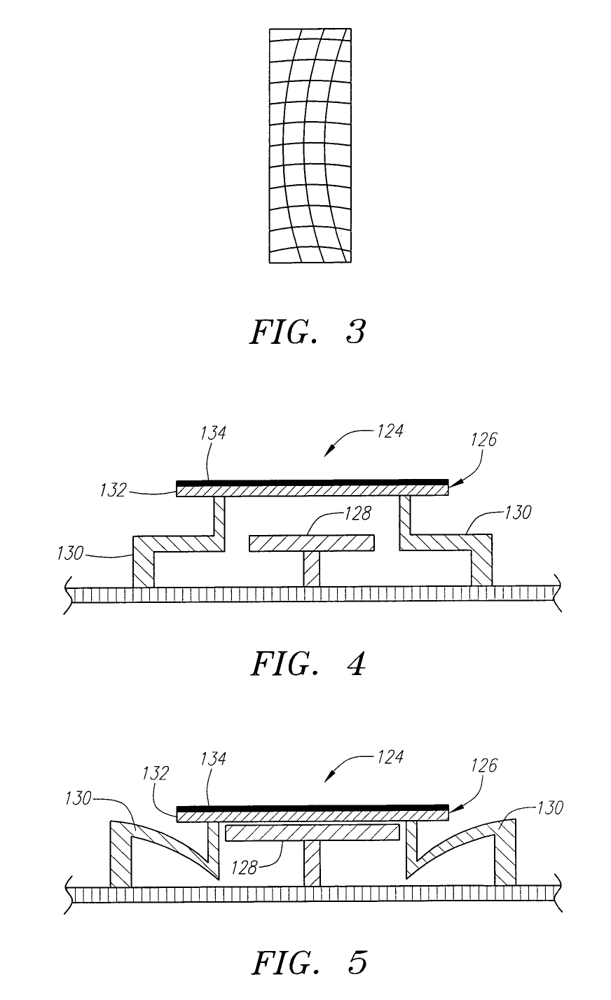

As can be seen from FIG. 2, it is assumed that the image of the candlestick falls within the selected grey-scale value or range, and thus, a small rectangular region representing the candlestick is selected for placement of the watermark pattern, as best shown in FIG. 3. It should be noted, however, that an optical image of a particular subject will seldom have a uniform grey-scale value, but rather will typically have various shades or tones. For example, if ambient light hits the candlestick 202 on one side, only a certain region or regions of the optical image representing the candlestick 202 may have the required grey-scale value or fall within the required grey-scale range. Thus, in practicality, a particular mask 212 will most likely have several small regions (which may only be the size of a pixel) selected for watermarking. This is advantageous in that the smaller the region that is watermarked, the less noticeable it will be to a casual observer of the film content.

It should also be noted that as the optical image received by the camera 100 changes (e.g., different subjects may be incorporated or removed from the scene, or the lighting may change), the spatial regions selected for watermarking, and thus the mask 212, will dynamically change through the series of film frames. Thus, although the entirety of the watermark pattern may remain uniform (at least through several film frames), the spatial region of the watermark pattern that is actually applied to the optical image will change. Thus, most, if not all, of the entire watermark pattern will be applied to the film over several frames, thereby spreading all of the information contained within the watermark pattern over the time domain.

After filtering the watermark pattern through the mask 212, the watermark controller 120 generates output signals that are sent to the optical modulator 106. The format of the output signals will depend on the architecture of optical modulator 106 and the manner in which it is controlled. In the illustrated embodiment, the optical modulator 106 takes the form of a reflective micro electrical-mechanical system (MEMS) array. Various reflective MEMS are currently available on the market today, examples of which are described in U.S. Pat. Nos. 6,587,613 and 6,704,475, which are expressly incorporated herein by reference. Reflective MEMS arrays typically employ a periodic array of micro-machined mirrors, each of which is individually movable in response to a signal (which may be an electrical, piezoelectric, magnetic, or thermal signal), so that optical paths of light reflecting off of each mirror can be selectively altered, thereby modifying any optical beam that is coincident with the MEMS array. In the illustrated embodiment, the individual mirrors of the reflective MEMS array are actuated in response to electrical control signals received from the watermark controller 120 of the watermarking device 108.

As illustrated in FIG. 4, a MEMS element array 120 can be topologically divided into a plurality of MEMS element sub-arrays 122, each of which comprises a plurality of MEMS elements 124 that can be selectively actuated to modulate a pixel-sized region in the optical image. Although each sub-array 132 is shown to include less than one hundred MEMS elements 124, in actuality, a particular MEMS sub-array 122 may contain hundreds, and even thousands, of MEMS elements 124, thereby allowing the optical image to be modulated with an extremely high resolution—even within a specific pixel-sized region. The actuation of the MEMS array 120 can be controlled in a standard manner, e.g., by assigning each MEMS element 124 with a digital address. In this case, the watermark controller 120 can selectively actuate the MEMS elements 124 by sending a signal to the addresses of these MEMS elements 124.

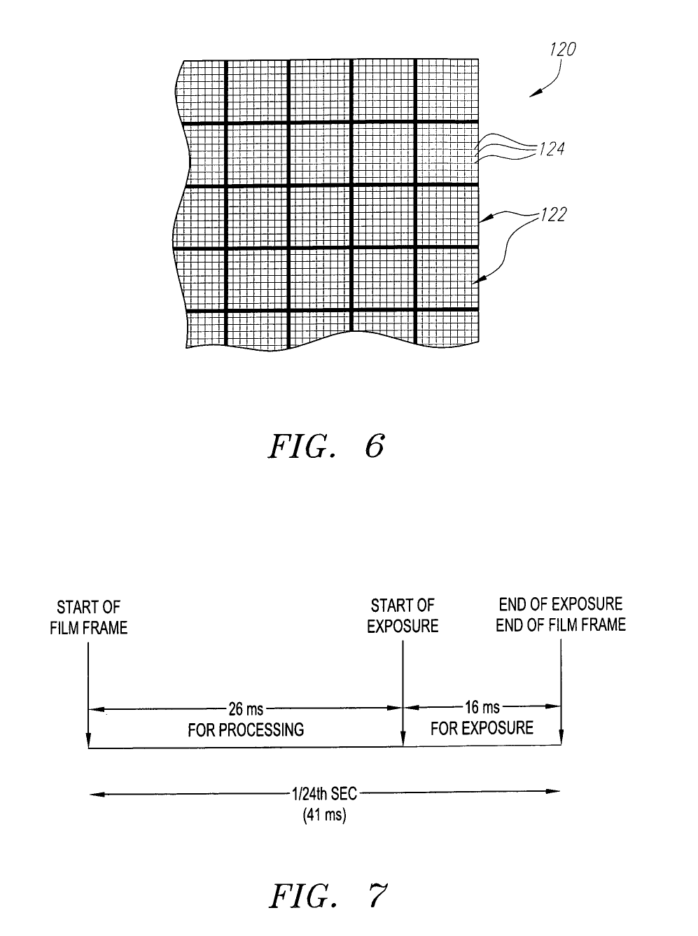

FIGS. 5 and 6 illustrate one element 124 of an exemplary reflective MEMS array 120 in further detail. The element 124 comprises a mirror 126, an electrode 128, and spring structures 130, which can be fabricated using standard micromachining processes, such as multilayer deposition and selective etching. The mirror 126 is composed of a material that reflects light with high reflectivity at a desired operating wavelength of the light, for example, an operating wavelength ranging from 800 nm to 1600 nm. In the illustrated embodiment, the mirror 126 comprises a polycrystalline silicon (polysilicon) membrane 132 on which a highly reflective film 134 is deposited using known film deposition techniques, such as evaporation, sputtering, electrochemical deposition, or chemical vapor deposition. The highly reflective film 134 can be composed of any suitable material, such as gold, silver, rhodium, platinum, copper, or aluminum. Alternatively, the polysilicon membrane 132, may itself, form the reflective surface of the mirror 126, although it may not be as reflective without the highly reflective film 134. The electrode 128 is disposed below the mirror 126 and can be composed of any suitable electrically conductive material, such as polysilicon. The mirror 126 is supported above the electrode 128 on the spring structures 130, which may be composed of the same material as the electrode 128 and flex in a resilient manner.

Thus, it can be appreciated that an electrical signal can be transmitted to either the mirror 126 or the electrode 128, which creates an electrostatic force that causes the mirror 126 to become attracted to the electrode 128. The spring structures 130 are then flexed, allowing the mirror 126 to move towards the electrode 128, thereby placing the MEMS element 124 in its deflected state (FIG. 6). As a result, any incident light becomes trapped within the MEMS array 120 and is absorbed by the MEMS element 124, thereby modulating any optical beam that reflects off of the MEMS array 120 by removing light from the portion of the optical beam that strikes the deflected MEMS element. When the electrical signal is removed, the static force between the mirror 126 and electrode 128 ceases, and the resiliency of the spring structures 130 cause the mirror 126 to move away from the electrode 128, thereby placing the MEMS element 124 back into its relaxed state (FIG. 5). As a result, any incident light is reflected by the MEMS element 124 along a nominal optical path.

Referring back to FIG. 4, it can be appreciated that as the number of actuated MEMS elements 124 increases in a given region, more light will be absorbed, thereby darkening the tone of the corresponding region of the modulated optical image. For example, if the grey-scale value of region of the optical image to be watermarked is 128, regions of the watermark pattern to be applied to that region may have grey-scale values ranging from 124 to 127.

Thus, the watermark pattern can be written onto the optical image by actuating selected elements within the MEMS element sub-arrays 122 spatially corresponding with the regions of the optical image to be modulated, with more MEMS elements 124 being actuated for darker regions of the watermark pattern. For example, to apply a region of the watermark pattern with a grey-scale value of 124 to an unmodulated region of the optical image with a current grey-scale value of 128, a percentage of those MEMS elements that spatially correspond to that region, which percentage will equate to 124/128, will be placed in their deflected states, so that the grey-scale value of the corresponding region in the optical image is reduced from 128 to 124. Similarly, to apply a region of the watermark pattern with a grey-scale value of 125 to the optical image, a percentage of those MEMS elements that spatially correspond to that region, which percentage will equate to 125/128, will be placed in their deflected states, so that the grey-scale value of the corresponding region in the optical image is reduced from 128 to 125. The grey-scale values of the regions of the optical image corresponding to the regions of the watermark pattern with grey scale values of 126 and 127 can be reduced in the same manner by setting the respective percentages of the deflected MEMS elements to be 126/128 and 127/128.

Thus, it can be appreciated that the watermark pattern can be applied to the optical image by placing a certain percentage of the spatially corresponding MEMS elements 124 in their deflected states to accordingly reduce the grey-scale values of the spatially corresponding region of the optical image. So that the region of the optical image spatially corresponding to each region of the watermark pattern visually appears as a solid color, the locations of the actuated or deflected MEMS elements 124 are preferably evenly distributed amongst the non-actuated or relaxed MEMS elements 124. In addition, it may be desirable to blur the line between modulated and unmodulated regions of the optical image in order to reduce the visibility of the watermark pattern to a casual observer. In this case, the percentage of deflected MEMS elements 124 at the fringes of the modulated region of the optical image may gradually be reduced to zero.

In some situations, it may be desired to increase the grey-scale values of certain regions of the optical image. This can be accomplished by adjusting the lens 102 to allow more light than normal to enter, such that the optical image that travels down the optical exposure path 110 towards the MEMS array 120 has a grey-scale value greater than normal, and biasing the MEMS array 120 by actuating a certain percentage of the MEMS elements 124, such that the optical image is modulated to reduce its grey-scale value to normal. For example, the lens 102 can be adjusted, such that the optical image is 2 F-stops brighter, in which case, seventy-five percent of the MEMS elements 124 can be actuated (i.e., seventy-five percent of light will be absorbed by the MEMS array 120), so that the brightness of the optical image can be returned to normal. Thus, a lighter watermark pattern region can written onto the optical image by placing some of the previously actuated MEMS elements 124 spatially corresponding within the regions of the optical image to be modulated into their relaxed state, thereby increasing the grey-scale value of the optical image in those regions. Of course, a darker watermark pattern region can still be written onto the optical image by actuating some of the previously unactuated MEMS elements within the regions of the optical image to be modulated into their deflected state, thereby decreasing the grey-scale value of the optical image in those region.

It should be noted that the grey-scale value with which a particular region of the optical image can be modulated can be controlled in other manners besides selecting the percentage of MEMS elements 124 that are to be actuated or deflected. For example, the MEMS elements 124 can be pulsed on and off, with the duty-cycle of each MEMS element 124 being equal to the desired percentage reduction of the gray-scale value for the spatially corresponding region of the optical image. For example, for a region of the optical image to be modulated from a grey-scale value of 128 to 124, the duty cycle of the spatially corresponding MEMS elements will be 124/128. Notably, the practical implementation of this modulation technique will be more complex than the previously modulation technique, but may perhaps be more advantageous in that the effective resolution of the MEMS array 120 may be increased (or the size of the MEMS array 120 may be reduced), since only a single MEMS element 124, rather than a group of MEMS elements 124, is required to control the grey-scale value of a modulated region of the optical image.

The film advancer 110 is configured for holding the photographic film 204 in the path of the watermarked optical image and for incrementally advancing the photographic film 208 by one frame in coordination with the optical switch 212. That is, after the optical switch 212 is placed into its processing state indicating the end of the current exposure, the film advancer 110 will advance the film 208 by one frame for subsequent exposure.

Having described the structure of the camera 100, a method of watermarking film content with the camera 100 during a single take will now be described with reference to FIG. 8. First, the watermark pattern 118 generates a watermark pattern using the key 114 and message information obtained from the message generator 116 (step 302). Notably, although the watermark pattern is described as being generated at the beginning of a take, it can be generated at any time during or before the watermarking process, and only needs to be performed when a different key 114 is to be selected or when the message generator 116 generates a new message.

Next, the optical mage 200 is received by the lens 102, where it is focused into an optical image beam and transmitted down the common optical path 206 towards the optical switch 212 (step 304). Next, the optical switch 212 temporally divides the optical image into a first optical image segment that is transmitted to the optical transducer (step 306). That is, at the beginning of the take, the optical switch 212 will be in its processing state, in which case, the optical image will travel from the common optical path down the optical processing path 208 to the optical transducer 104. Then, the optical transducer 104 transforms the optical image segment into digital video data (grey-scale values) and transmits it to the watermark controller 120 of the watermarking device 106 (step 308).

Next, the watermark controller 120 analyzes the digital video data by determining the spatial regions in the optical image that the watermark is to be applied, and in particular, determining the spatial regions in the optical image that have a specific grey-scale value or fall within a specific grey-scale range (step 310). The watermark controller 120 then configures the optical modulator 108 to modulate the selected region(s) of the optical image with the watermark pattern (step 312). In particular, the watermark controller 120 generates a mask based on these selected region(s), filters the watermark pattern through the mask, and transmits control signals representing the filtered watermark pattern to the optical modulator 108, which configures itself to modulate the selected region(s) of the optical image with the watermark.

Next, the optical switch 212 is placed into its exposure state to temporally divide the optical image into a second optical image segment that is transmitted from the common optical path 206 down the optical exposure path 210 to the optical modulator (step 314). Next, the optical modulator 108 optically applies the watermark to the second optical image segment to generate an optical watermarked optical image segment, which then continues to travel down the optical exposure path 210 to the photographic film 204 (step 316). In particular, the spatial regions of the second optical image segment are modulated by the deflected MEMS elements 124 as the second optical image segment reflects off of the MEMS array 120. One frame of the film 204 is then exposed to the watermarked optical image segment, thereby forming an image into the film (step 318).

Next, the film advancer 110 advances the film to the next frame (step 320) and the optical switch 212 is placed into its processing state to temporally divide the optical image into a third optical image segment that is transmitted from the common optical path 206 to the optical transducer 104 (step 322). Steps 304-318 are then repeated to form another image into subsequent frames of the film 204.

Although a camera and method have been described for advantageously applying a watermark to an optical image at the creation of the film content, it should be noted that the camera and method can be modified for other applications as well using similar components. For example, it may be useful to apply the tracking information to the optical image without the use of a watermark, so that the tracking information may actually be visually noticed in the film content. It may also be useful to correct optical images before film exposure.

For example, FIG. 9 illustrates another exemplary camera 400 constructed in accordance with the present invention. The camera 400 is configured for simultaneously capturing and applying a message to optical image 200 of the subject 202 on photographic film 204. The camera 400 is similar to previously described camera 100, with the exception that tracking information is applied to the optical image without a watermark and without analyzing the optical image. In this case, there is only a single optical path 406 along which the optical image travels. The camera 400 comprises an optical switch 412 in the form of a standard shutter, which temporally divides the optical images into a series of optical image segments that are transmitted to, and modulated by, the optical modulator 108, and then sent to the film holder 204, which exposes the respective series of film frames to the modulated optical image segments. The optical modulator 108 modulates the optical image segments in response to control signals transmitted by a controller 420, which may take the form of a DSP. These control signals are generated in response to message information generated by the message generator 116. As previously described, this message information can take the form of tracking information. Thus, the message information generated by the message generator 116 will be applied to the optical image segments.

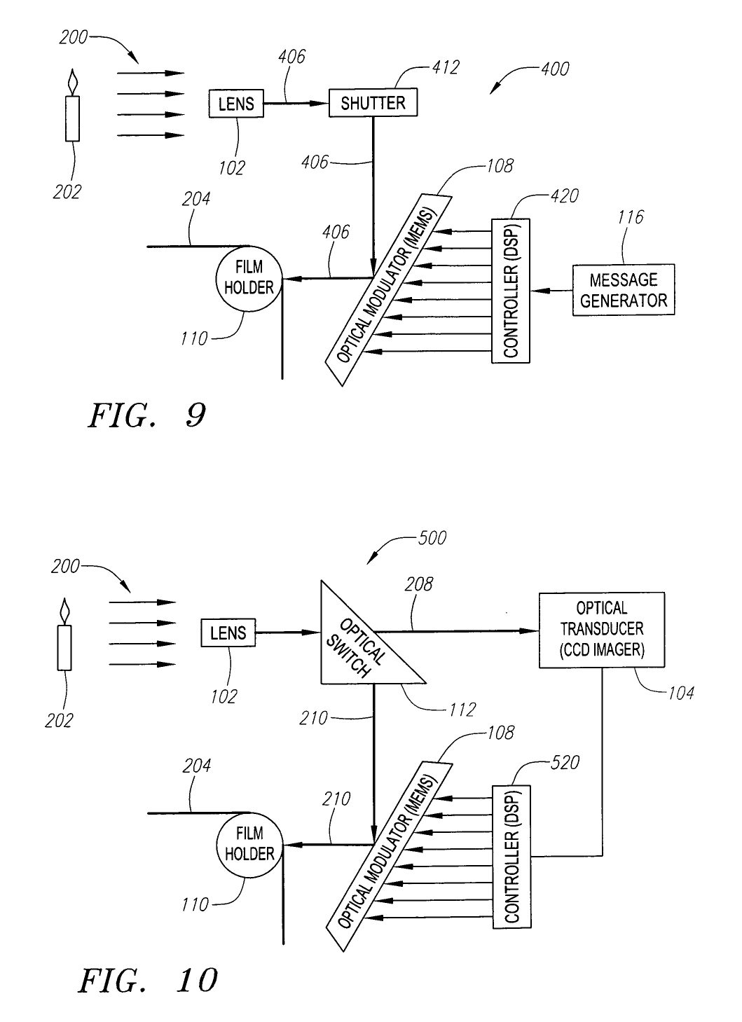

As another example, FIG. 10 illustrates still another exemplary camera 500 constructed in accordance with the present invention. The camera 500 is configured for correcting an optical image 200 of the subject 202 and exposing the photographic film 204 to the corrected optical image 200. The camera 500 is similar to the previously described camera 100, with the exception that the optical image is modulated to improve the quality of the film content, rather than to apply a watermark to the film content. In particular, the camera 500 comprises a controller 520, which analyzes the digital video data received from the optical transducer 104 and identifies regions of the optical image that may require correction.

As one example, when shooting a shadow in daylight, the shadow may be too dark, and thus, not show up on the film very well. In contrast, the sunlight may be too light, resulting in the film being washed out in this area. Typically, one could control the F-stop on the camera to allow more or less light into the lens. However, only one of the above problems can be fixed at the expense of the other. That is, the lens can be adjusted to allow more light into the camera, so that more detail is shown in the shadow region, but the problematic lighted region will be washed out even more. By the same token, the lens can be adjusted to allow less light into the camera, so that the lighted regions is not washed out, but the problematic shadow region will lose even more detail.

The camera 500 is capable of fixing both problems at the same time. In particular, the controller 520 can determine regions of high contrast based on the grey-scale values of the digital video data. The controller 520 can then generate control signals based on this analysis, which are then sent to the optical modulator 108 to modulate the problematic regions of the optical image. In particular, the overly lighted regions of the optical image can be darkened by actuating a higher percentage of the MEMS elements 124 (relative to a nominal percentage of actuated MEMS elements 124) to reduce the grey-scale values of the overly lighted regions. The overly darkened regions of the optical image can be lightened by actuating a lower percentage of the MEMS elements 124 (relative to the nominal percentage of actuated MEMS elements 124). Thus, it can be appreciated that the camera 500 is capable of independently correcting any region in the optical image.

Although particular embodiments of the present invention have been shown and described, it will be understood that it is not intended to limit the present invention to the preferred embodiments, and it will be obvious to those skilled in the art that various changes and modifications may be made without departing from the spirit and scope of the present invention. Thus, the present inventions are intended to cover alternatives, modifications, and equivalents, which may be included within the spirit and scope of the present invention as defined by the claims.

1. A method of watermarking film content, comprising:
receiving an optical image;
generating a watermark;
optically applying the watermark to the optical image to generate a watermarked optical image; and
exposing photographic film to the watermarked optical image.

2. The method of claim 1, further comprising analyzing the optical image, wherein the watermark is applied to the optical image based on the analysis.

3. The method of claim 2, wherein the analysis of the optical image comprises determining one or more spatial regions in the optical image to which the watermark is applied.

4. The method of claim 2, further comprising:
determining spatial regions in the optical image that have a specific grey-scale value or fall within a specific grey-scale range; and
selecting one or more of the determined spatial regions to which the watermark is applied.

5. The method of claim 1, wherein the watermark is applied by absorbing light from the optical image.

6. The method of claim 1, further comprising creating a movie by repeatedly performing the watermark generation, watermark application, and exposure steps over a series of film frames.

7. The method of claim 6, wherein the film is exposed to the watermarked optical image in real-time.

8. The method of claim 1, wherein the watermark comprises tracking information.

9. The method of claim 1, wherein the watermark comprises correlated noise.

10. The method of claim 1, wherein the watermark is a watermark pattern.

11. A method of watermarking film content, comprising:
receiving an optical image;
temporally dividing the optical image into first and second optical image segments;
analyzing the first optical image segment;
generating a watermark;
optically applying the watermark to the second optical image segment based on the analysis to generate an watermarked optical image; and
exposing photographic film to the watermarked optical image segment.

12. The method of claim 11, further comprising transforming the first optical image segment into digital video data, wherein the analysis of the first optical image segment comprises analyzing the digital video data.

13. The method of claim 11, wherein the analysis of the first optical image segment comprises determining one or more spatial regions in the second optical image segment to which the watermark is applied.

14. The method of claim 11, further comprising:
determining spatial regions in the first optical image segment that have a specific grey-scale value or fall within a specific grey-scale range;
selecting one or more of the spatial regions of the first optical image segment, wherein the watermark is applied to one or more spatial regions of the second optical image segment corresponding with the selected one or more spatial regions of the first optical image segment.

15. The method of claim 11, wherein the watermark is applied by absorbing light from the second optical image segment.

16. The method of claim 11, further comprising creating a movie by repeatedly performing the optical image division, analysis, watermark generation, watermark application, and exposure steps over a series of film frames.

17. A method of incorporating tracking information into film content, comprising:
receiving an optical image;
generating the tracking information;
modulating the optical image with the tracking information; and
exposing photographic film to the modulated optical image.

18. The method of claim 17, wherein the optical image is modulated by absorbing light from the optical image.

19. The method of claim 17, further comprising creating a movie by repeatedly performing the tracking information generation, optical image modulation, and exposure steps over a series of film frames.

20. The method of claim 19, wherein the film is exposed to the modulated optical image in real-time.

21. A camera for watermarking film content, comprising:
a lens for receiving an optical image;
a watermarking device configured for generating watermark control signals;
an optical modulator configured for modulating the optical image in response to the watermark control signals; and
a film advancer configured for exposing photographic film to the modulated optical image.

22. The camera of claim 21, wherein the watermarking device is further configured for analyzing the optical image, and for generating the watermark control signals based on the analysis.

23. The camera of claim 22, further comprising an optical transducer configured for transforming the optical image into digital video data, wherein the watermarking device analyzes the digital video data.

24. The camera of claim 23, wherein the optical transducer comprises one or more Charge Coupled Device (CCD) imagers.

25. The camera of claim 21, wherein the watermark generator comprises a watermark controller configured for selecting one or more spatial regions in the optical image to be modulated by the optical modulator.

26. The camera of claim 21, wherein the watermark generator comprises a watermark controller configured for determining spatial regions in the optical image that fall within the specific grey-scale range, and selecting one or more of the spatial regions to be modulated by the optical modulator.

27. The camera of claim 21, further comprising an optical switch configured for temporally dividing the optical image into a series of optical image segments that expose a respective series of photographic film frames, wherein the optical modulator is configured for modulating at least two of the optical image segments in response to the watermark control signals.

28. The camera of claim 21, wherein the watermark generator comprises a message generator configured for generating tracking information, and a watermark pattern generator configured generating a watermark pattern containing the tracking information.

29. The camera of claim 21, wherein the optical modulator comprises a reflective Micro Electrical-Mechanical System (MEMS) array.

30. The camera of claim 21, wherein the watermark comprises correlated noise.

31. The camera of claim 21, wherein the watermark generator comprises a watermark pattern generator configured for generating a watermark pattern.

32. The camera of claim 21, further comprising a housing containing the lens, watermarking device, optical modulator, and film advancer.

33. A camera for watermarking film content, comprising:
a lens for receiving an optical image;
an optical switch configured to be placed in a first state that transmits a first time segment of the optical image along a first optical path, and a second state that transmits a second time segment of the optical image along a second optical path;
a watermarking device configured for analyzing the first time segment of the optical image and generating watermark control signals in response thereto;
an optical modulator configured for modulating the second time segment of the optical image in response to the watermark control signals; and
a film advancer configured for exposing photographic film to the modulated optical image segment.

34. The camera of claim 33, wherein the optical switch comprises a rotating shutter.

35. The camera of claim 33, further comprising an optical transducer configured for transforming the first time segment of the optical image into digital video data, wherein the watermarking device is configured for analyzing the digital video data.

36. The camera of claim 33, wherein the optical transducer comprises one or more Charge Coupled Device (CCD) imagers.

37. The camera of claim 33, wherein the watermark generator comprises a watermark controller configured for selecting one or more spatial regions in the second time segment of the optical image to be modulated by the optical modulator.

38. The camera of claim 33, wherein the watermark generator comprises a watermark controller configured for determining spatial regions in the first time segment of the optical image that fall within the specific grey-scale range, and selecting one or more of the spatial regions, and wherein the optical modulator modulates one or more spatial regions of the second optical image segment corresponding with the selected one or more spatial regions of the first optical image segment.

39. The camera of claim 33, wherein the optical modulator comprises a reflective Micro Electrical-Mechanical System (MEMS) array.

40. The camera of claim 33, further comprising an optical switch configured for temporally dividing the optical image into a series of optical image segments that expose a respective series of photographic film frames, wherein the optical modulator is configured for modulating at least two of the optical image segments in response to the watermark control signals.

41. The camera of claim 33, further comprising a housing containing the lens, optical switch, watermarking device, optical modulator, and film advancer.

42. A camera incorporating tracking information into film content, comprising:
a lens for receiving an optical image;
a message generator configured for generating the tracking information;
an optical modulator configured for modulating the optical image with the tracking information; and
a film advancer configured for exposing photographic film to the modulated optical image.

43. The camera of claim 42, wherein the optical modulator comprises a reflective Micro Electrical-Mechanical System (MEMS) array.

44. The camera of claim 42, further comprising a housing containing the lens, message generator, optical modulator, and film advancer

45-67. (canceled)
